(19) United States
(12) Patent Application Publication
(10) Pub. No.: US 2015/0154625 A1
(43) Pub. Date: Jun. 4, 2015

(54) Reward Program for Financial Accounts

(71) Applicant: Bank of America Corporation, Charlotte, NC (US)

(72) Inventors: Elizabeth L. Basnight, Wilmington, DE (US); John Livaditis, Wilmington, DE (US); Faith Hepler, Wilmington, DE (US); Phyllis Thesing, Charlotte, NC (US); Erica Geers, Chicago, IL (US); Colleen Novielli, Philadelphia, PA (US); Eric Charles Boyd, New London Township, PA (US)

(21) Appl. No.: 14/618,634

(22) Filed: Feb. 10, 2015

Related U.S. Application Data
(63) Continuation of application No. 13/748,220, filed on Jan. 23, 2013.

(51) Int. Cl. G06Q 30/02

(52) U.S. Cl. CPC G06Q 30/0215; G06Q 30/0226

(57) ABSTRACT

A computer system enables a financial institution to award a fixed reward that may include one or more fixed components based on at least one payment criterion when a customer remits a payment in a timely basis. The payment criteria, for example, may include paying a minimum amount for each consecutive billing period in a timely manner over a predetermined calendar interval. When the customer is awarded the fixed reward, the reward may be directed to an account that is designated by the customer. The fixed reward may also include a basic fixed amount for satisfying the at least one payment criterion a well as an additional fixed amount if the customer has a specified relationship (such as a checking and/or a savings account) with the financial institution.

### CROSS-REFERENCE TO RELATED APPLICATION

This application is a continuation of U.S. application Ser. No. 13/748,220 filed on Jan. 23, 2013, entitled “Reward Program for Loan Accounts,” which is incorporated herein by reference in its entirety.

### FIELD

Aspects described herein relate to a computer system that provides a fixed reward to a consumer for a financial account including a loan payment, such as with a credit card account in accordance with payment criteria, and including a deposit or savings account.

### BACKGROUND

Loans are very important to the proper functioning of the financial systems of the world. Like all debt instruments, a loan entails the redistribution of financial assets over time, between the lender and the borrower. With a loan, the borrower initially receives or borrows an amount of money, called the principal, from the lender, and is obligated to pay back or repay an equal amount of money to the lender at a later time. Typically, the money is paid back in regular installments or partial repayments. A loan is generally provided at a cost, referred to as interest on the debt, which provides an incentive for the lender to engage in the loan.

There are different types of loans including credit card, debit card, mortgage, home equity, automobile, consumer finance, and student loans. As an example, a credit card typically entitles its holder to buy goods and services based on the holder's promise to pay for these goods and services. The issuer of the card grants a line of credit to the consumer from which the consumer can borrow money for payment to a merchant or as a cash advance to the user. In order to encourage usage, many credit card customers receive rewards, e.g., frequent flyer points, gift certificates, or cash back, as an incentive to make purchases with the credit card. Moreover, while reward points may encourage spending by consumers, reward points may have the unintended result of consumers overextending their financial capability. Thus, it is desirable that a reward program encourage responsible payment behavior in order to benefit both financial institutions as well as consumers.

### BRIEF SUMMARY

Aspects described herein address one or more of the issues mentioned above by disclosing methods, computer readable media, and apparatuses that enable a financial institution (e.g., a credit card company) to award an account a fixed amount that may include one or more fixed components when a customer remits a payment in a timely basis. Consequently, a financial institution encourages repayment of debt and recognizes good behavior through the fixed reward over a predetermined period of time (e.g., for each of the three billing cycles of a calendar quarter) for paying at least a minimum amount in a timely manner. When the customer is awarded the fixed reward, the reward can be directed to an account as designated by the customer.

With another aspect of the embodiments, awarding a fixed reward is based on a set of payment criteria. For example, the payment criteria may include paying a minimum amount for each consecutive billing period in a timely basis over a calendar quarter. However, some embodiments of the embodiments may support different calendar intervals and a reward for a fixed amount reward and/or for a fixed percentage of the purchase amount.

With another aspect of the embodiments, a customer is automatically enrolled in the fixed reward program when the customer successfully applies for a credit card with the financial institution.

With another aspect of the embodiments, a fixed reward includes first and second fixed amounts. The first fixed amount is directed to the customer's designate account when the customer satisfies payment criteria. In addition, if the customer has a specified relationship (e.g., having a savings and/or checking account) with the financial institution, the customer may be presented a second fixed amount to the same customer's designated account. With another aspect of the embodiments, a customer may designate a different account for the second fixed amount than for the first fixed reward amount. With another aspect of the embodiments, reward criteria may be adjusted from a monthly/quarterly assessment calendar to other intervals such as a quarterly assessment for annual reward allocation.

Aspects of the embodiments may be provided in a computer-readable medium having computer-executable instructions to perform one or more of the process steps described herein.

These and other aspects of the embodiments are discussed in greater detail throughout this disclosure, including the accompanying drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative operating environment in which various aspects of the invention may be implemented.

FIG. 2 is an illustrative block diagram of workstations and servers that may be used to implement the processes and functions of certain aspects of the present invention.

FIG. 3 shows a flow diagram for analyzing customer payment behavior in accordance with an aspect of the invention.

FIG. 4 shows a flow diagram for analyzing payment behavior based on payment criteria in accordance with an aspect of the invention.

FIG. 5 shows a flow diagram for directing a fixed reward payment to a customer's account in accordance with an aspect of the invention.

FIG. 6 shows a flow diagram for associated processing of customer payments in accordance with an aspect of the invention.

FIG. 7 shows a flow diagram for payment cycle change mitigation in accordance with an aspect of the invention.

FIG. 8 shows an exemplary screenshot in which a customer designates an account for fixed rewards crediting in accordance with an aspect of the invention.

### DETAILED DESCRIPTION

In accordance with various aspects of the embodiments, methods, computer-readable media, and apparatuses are disclosed in which a reward with at least one fixed components are awarded to a designated account when a customer remits a payment in a timely basis for a credit card account. Consequently, a financial institution encourages repayment of debt and recognizes good behavior through a reward when the customer makes payments in accordance with at least one payment criterion.

While the product construct is applicable to a credit card environments, embodiments may be extended to include other loan products, including mortgages, home equity, auto, and student loans. In addition, embodiments may support other financial accounts, e.g., deposit or savings accounts in which a fixed reward is determined for deposit goals. For example, a customer may establish a goal of depositing a designated amount of money per month into a savings account. In accordance with an aspect, embodiments may support collected customer research that is indicative that the product construct meets a customer need.

With an aspect of the embodiments, when a customer is approved for a credit card with a financial institution, the customer is automatically enrolled in a rewards program that supports a fixed component based on payment criteria. For example, a rewards program may be an inherent feature of a credit card product, in which the feature automatically comes with the card and no specific enrollment is required. However, some embodiments may require specific enrollment in the rewards program to obtain a fixed reward.

With an aspect of the embodiments, a customer's credit card may comprise an identification image (e.g., picture and/or biometric identification of the customer) and/or an embedded chip for authentication of the customer.

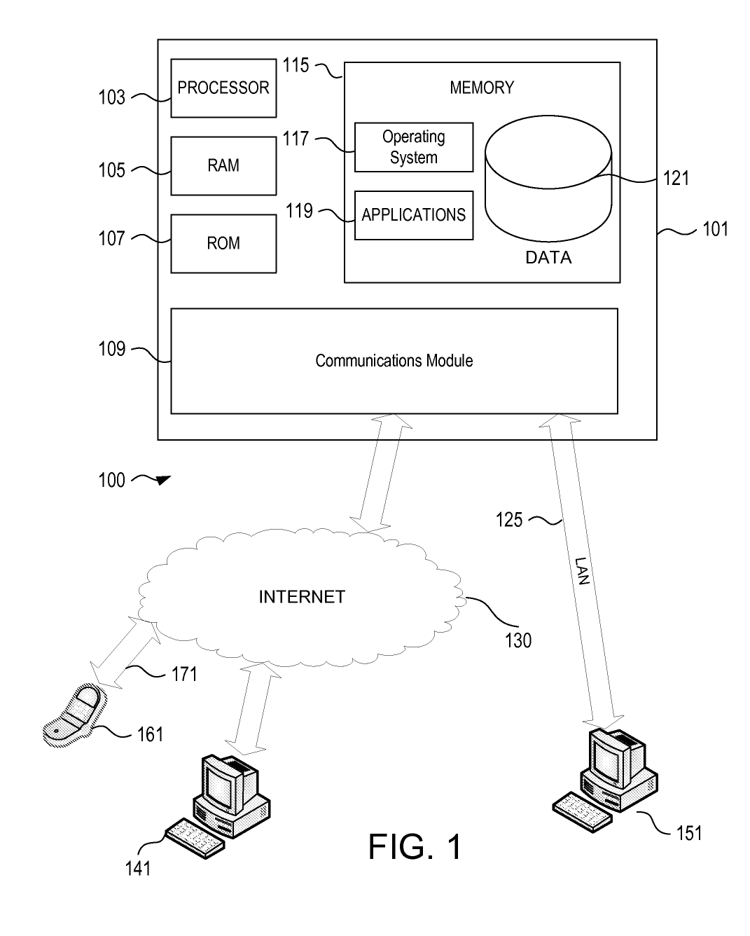

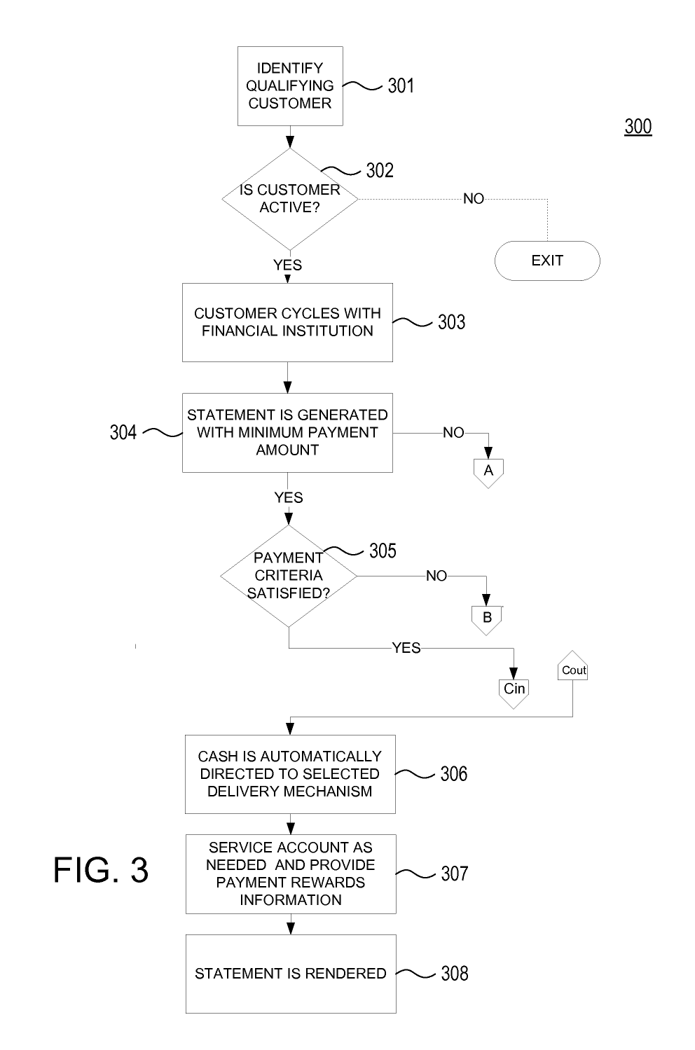

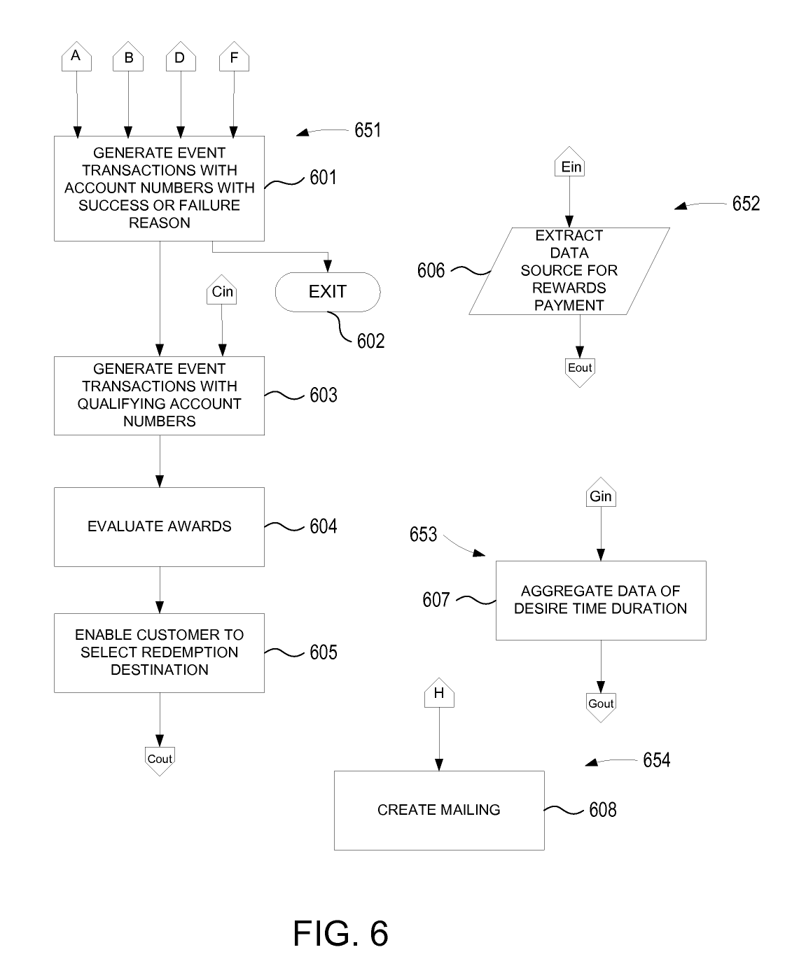

FIG. 1 illustrates an example of a suitable computing system environment 100 (e.g., for processes 300, 400, 500, and 700 as shown in FIGS. 3, 4, 5, and 7, respectively and for processes 651-654 as shown in FIG. 6) that may be used according to one or more illustrative embodiments. The computing system environment 100 is only one example of a suitable computing environment and is not intended to suggest any limitation as to the scope of use or functionality of the invention. The computing system environment 100 should not be interpreted as having any dependency or requirement relating to any one or combination of components shown in the illustrative computing system environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including RAM 105, ROM 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence and receipts to digital files.

Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of the computer executable instructions for computing device 101 may be embodied in hardware or firmware (not shown). Database 121 may provide centralized storage of loan information, e.g., credit card statements, that may be received from different points in system 100, e.g., computers 141 and 151 or from communication devices, e.g., communication device 161.

Computing device 101 may operate in a networked environment supporting connections to one or more remote computing devices, such as branch terminal 151. Branch computing devices 151 may be a personal computing device or server that may include many or all of the elements described above relative to the computing device 101.

A customer may access the customer's account information though Internet 130 using computing device such as personal computing device 141 or mobile device 161. Mobile device 161 may be a mobile device communicating over wireless carrier channel 171 through Internet 130.

The network connections depicted in FIG. 1 include a local area network (LAN) 125 and Internet 130, but may also include other networks. When used in a LAN networking environment, computing device 101 is connected to the LAN 125 through a network interface or adapter in the communications module 109. When used in a wide area network (WAN) networking environment, the server 101 may include a modem in the communications module 109 or other means for establishing communications, such as the Internet 130. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. The network connections may also provide connectivity to a CCTV or image/iris capturing device.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the invention may include forms of computer-readable media. Computer-readable media include any available media that can be accessed by a computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the invention is contemplated. For example, aspects of the method steps disclosed herein may be executed on a processor on a computing device 101. Such a processor may execute computer-executable instructions stored on a computer-readable medium.

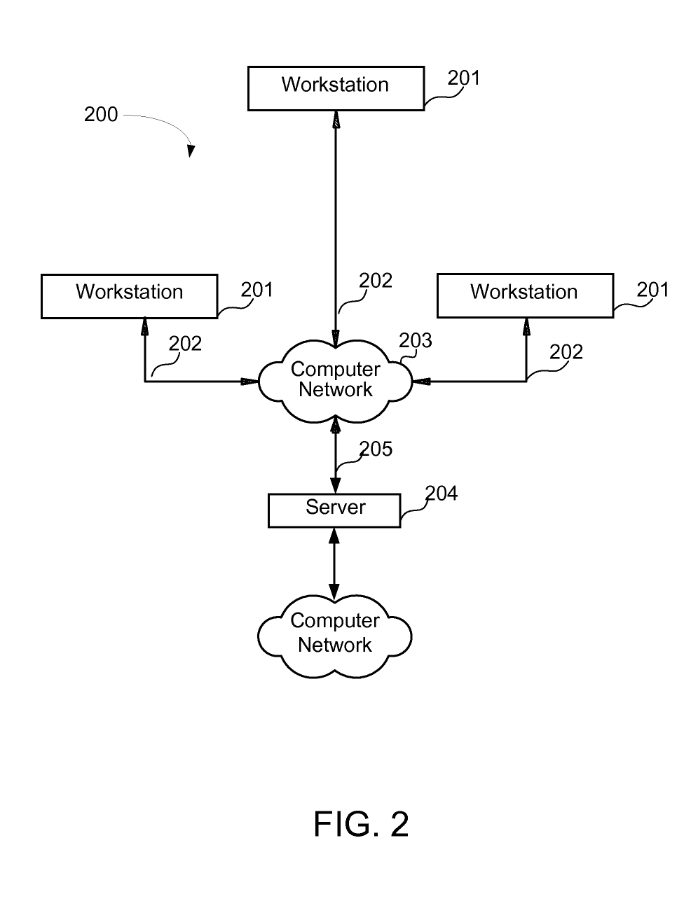

Referring to FIG. 2, an illustrative system 200 for implementing methods according to the present invention is shown. As illustrated, system 200 may include one or more workstations 201 within a financial institution's processing network. Workstations 201 may be local or remote, and are connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, and hard-wired links. Connectivity may also be supported to a CCTV or image/iris capturing device.

The steps that follow in the Figures may be implemented by one or more of the components in FIGS. 1 and 2 and/or other components, including other computing devices.

FIG. 3 shows flow diagram 300 for analyzing customer payment behavior in accordance with an aspect of the invention. Process 300 provides a reward to a customer comprising one or more fixed cash components for responsible payment behavior based on predetermined payment criteria. With an embodiment, process 300 supports a credit card program that gives a customer up to a maximum fixed amount during a year for what the customer does, not for how much the customer spends against the customer's credit card provided by a financial institution. For example, every time a customer pays a bill on time and more than the minimum for three consecutive months, the customer may receive $25 per calendar quarter that is either automatically deposited into an account of the customer's choice or applied toward the customer's card balance. Consequently, the customer may receive up to $100 a year in rewards. With some embodiments, the reward may not be applied as a payment towards the loan.

With another aspect of the embodiments, when a customer opens a new account during a calendar interval (e.g., a given calendar quarter), the qualifying payment criteria may be relaxed for that given calendar interval only to allow reward qualification even if all the payment criteria have not been met for the entirety of that given calendar interval. For example, as long as the customer meets the at least one payment criterion for all billing cycles in the given calendar interval following the account opening, the customer receives the reward (e.g., even if the customer did not make three monthly payments for that first quarter since the customer opened the account mid-way in the calendar quarter).

With another aspect of the embodiments, the customer may receive an additional fixed amount (e.g., $5 per quarter) when the customer has established a specific relationship with the financial institution. For the example, the customer may have a checking and/or savings account with the financial institution. Consequently, the customer may receive two fixed components per billing cycle that include the basic amount as well as the bonus amount (e.g., $25 plus $5 or $30 per calendar quarter in the above example). A competitive introductory rate may be offered for both purchases and balance transfers. With some embodiments, targeted customers may receive a direct mail offer that includes an extended period for the introduction rate. In addition, the rewards program may provide additional rewards for balances transferred as an incentive and/or use a reward to pay bank transfer charges.

Referring to FIG. 3, a customer is identified a block 301, in which the customer qualifies to participate in the rewards program. For example, the customer with a credit card account is verified to be of good standing. Process 300 determines whether the qualifying customer is active, e.g., using the credit card within a predetermined time interval, at block 302. In addition, with some embodiments, a reward may be restricted to customers that who have a retail spend above a threshold in each of the billing cycles of the period.

If so, process 300 accesses the customer's billing information for the billing cycle at block 303 and generates a billing statement at block 304. The billing statement may include the minimum amount that is due for that billing cycle. With some embodiments, however, a customer may request that a specified fixed amount (e.g., $50) over the minimum amount be included in the billing statement so that the customer can pay off the balance in more expeditious manner. However, some embodiments may support an automated payment only for a minimum, fixed, or full balance. Also, the customer may have the set amount automatically withdrawn from a designated account (e.g., savings, checking, or debit). With some embodiments, the minimum amount may be adjusted according to a pay-down calculation developed by user-friendly online tools so that the customer can pay off the credit card debt based the associated interest rate. If a billing statement is not generated at block 304 (for example, there are no transactions during the billing period), process 300 may generate a transaction event via a web service or batch service noting the reason via process 651 as shown in FIG. 6.

At block 305, process 300 then determines whether the customer has satisfied predetermined payment criteria for past payments. For example, the payment criteria may span the last three monthly statements over the last quarter and include paying at least the minimum amount in a timely manner. However, the payment criteria may include different criteria such as the customer having a minimum numbers of transactions and/or minimum amount of purchases. If the customer has not satisfied the predetermined payment criteria, process 300 may generate a transaction event via a web service or batch service noting the reason via process 651 as shown in FIG. 6.

If the predetermined criteria are satisfied, one or more fixed amounts are directed to one of the customer's accounts at block 306 via process 651 as shown in FIG. 6 (which will be discussed in further detail). For example, a fixed amount may be directed to the customer's savings or checking account as designated by the customer or can be credited to the customer's credit card account by default.

At block 307, process 300 may enable the account to be serviced if there are inquiries from the customer (for example via the web site) or generate promotion offerings to customers regarding the rewards program. Also, at block 308, the billing statement may be displayed (for example via the web site) to include the payment rewards status to the customer.

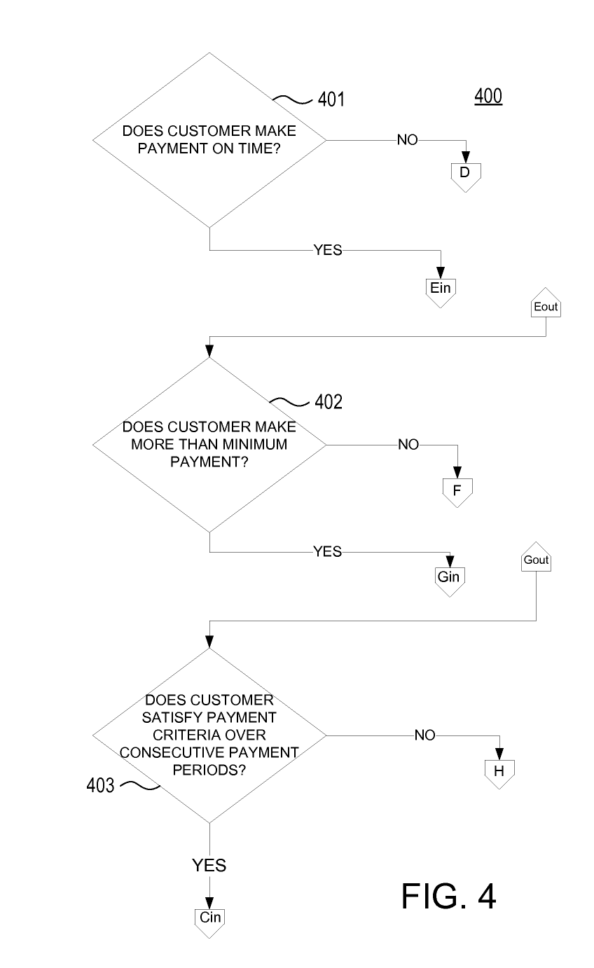

FIG. 4 shows flow diagram 400 for analyzing payment behavior based on payment criteria in accordance with an aspect of the invention. With some embodiments, as shown in FIG. 4, the payment criteria include the customer making payments on the time for at least the minimum amount over a predefined reward time interval. For example, a billing cycle and the predefined reward time interval may span over a month and a calendar quarter, respectively. However, the predefined reward time duration and billing cycles may span different intervals. For example, the billing cycle may span a portion of a month (e.g., 28 days) and the predefined reward time interval may be a half of a year. With some embodiments, the customer may choose a reward time interval that is different from the timeline established by the financial institution.

Referring to FIGS. 3 and 4, block 305 (“payment criteria satisfied” as shown in FIG. 3) may be performed by blocks 401 (“Does customer make payment on time”), 402 (“Does customer make more than minimum payment?”), and 403 (“Does customer satisfy payment criteria over consecutive payment periods”). The total minimum payment due, for example, equals 1% of the new balance total plus new interest charges (if applicable) plus new late charges (if applicable), where the customer's total minimum payment due is not less than $25.00 unless it equals the customer's new balance total.

With some embodiments may support different payment criteria, including a minimum level of spending for the credit account, a minimum number of transactions for the credit account, and/or a predetermined payment amount over a minimum amount. As another example, a payment criterion may include paying a fixed percentage over the minimum due amount.

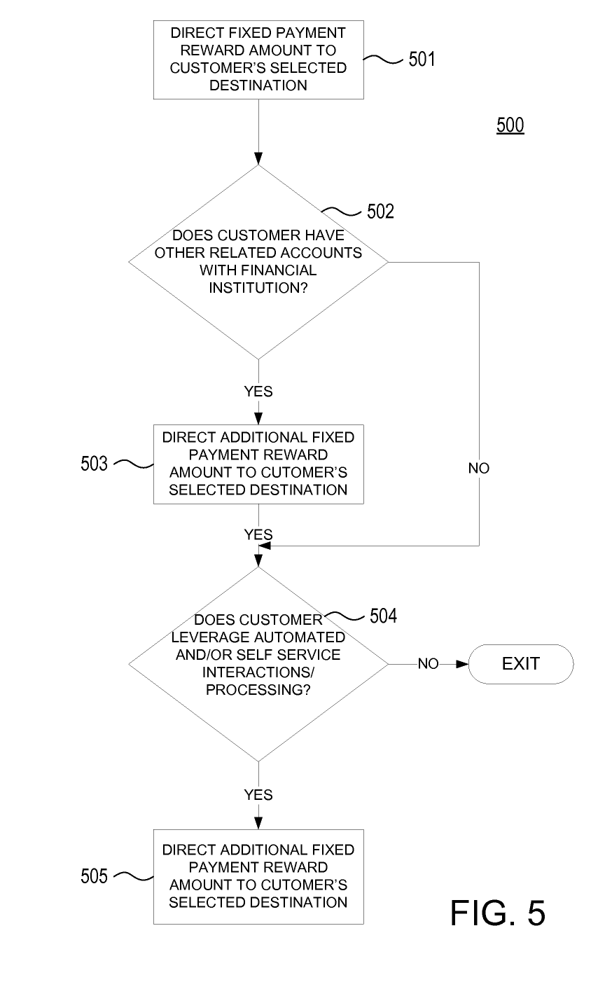

FIG. 5 shows flow diagram 500 for directing a fixed reward payment to a customer's account in accordance with an aspect of the invention. Process 500 may be executed in conjunction with process 300 (in reference to block 306) as shown in FIG. 3 and process 651 (in reference to block 604 (evaluate rewards) as shown in FIG. 6).

A first fixed component of the fixed reward is directed to the customer's selected destination at block 501. For example, as shown in FIG. 4, the customer is presented a basic fixed component when the customer pays a minimum amount in a timely basis over a predetermined time interval, e.g., a calendar quarter. While fixed at a particular time, with some embodiments the fixed rewards components may be adjusted according to a predetermined economic characteristic, for example, where the fixed reward is increased in accordance with the annual inflation rate so that the fixed reward can be adjusted on an annual basis. As another example, a financial institution may offer different tiers of a financial product (e.g., credit card), where the benefits and the fixed reward amount may be increased with a nominal annual charge and/or with a higher deposit relationship with the financial institution. As another example, different levels of rewards may be established based on a selection of criteria to be met, e.g., paying on time get $5, paying more than a minimum get $25, while paying 30% or more of balance get $50. As another example, a fixed reward amount may be different for different customer segments, e.g., a customer who is emerging from financial stress may have a low credit line and may want rewards, which may require financial justification by providing less than the nominal fixed reward amount. As another example, if the financial institution issues credit cards and services for a partner business (e.g., a merchant or another financial organization) the partner business may set different reward levels with respect to the financial institution and other partner businesses.

With some embodiments, additional rewards may be provided for key life events, e.g., get an added $25 when the customer graduates, marries, or buys a new home. With some embodiments, if a life event occurs, the customer may get a waiver for meeting payment criteria for that month of the event in order to obtain a reward.

With some embodiments, if customer has multiple loan products with the financial institution and the same payment criteria are satisfied for all of the loan products, the customer obtains an even bigger fixed reward than with a single product.

A customer may be awarded additional fixed components in conjunction with the basic fixed component. With some embodiments, a second fixed component may be directed to the customer's designated account when the customer a specific relationship with the financial institution. For example, process 500 determines whether the customer has other accounts (e.g., savings and checking) with the financial institution at block 502. If so, the second fixed amount is directed to the customer's designated account at block 503.

Embodiments may incorporate other fixed components based on other criteria. For example, a third fixed component may be presented at blocks 504 and 505 if the customer makes a credit card payment on-line rather than making the payment via U.S. mail and/or if the customer has a home loan with the financial institution.

FIG. 6 shows a flow diagram for associated processing of customer payment in conjunction with process 300 as shown in FIG. 3 and with process 400 as shown in FIG. 4 according to an aspect of the invention. For example, with some embodiments, the associated processing may be performed in a “behinds-the-scene” manner (e.g., on a different computer system) that may not be explicitly perceived by the customer.

Process 651 (blocks 601-605) generated transaction events for a customer's account. The fixed reward is determined from qualifying transactions so that the reward can be directed to the customer's designated account.

Process 652 (block 606) accesses payment data so that the minimum payment. Referring to FIG. 4, block 402 uses this information to determine whether the customer makes more than the minimum payment for a billing cycle.

Process 653 (block 607) aggregates payment information over consecutive billing cycles so that block 403 (as shown in FIG. 4) can determine whether a customer satisfies the payment criteria over a predetermined number of consecutive billing cycles (e.g., over the calendar quarter).

Process 654 (block 608) generates a mailing (e.g., via e-mail or U.S. mail) to inform the customer about the rewards program if the customer does not qualify a fixed reward during the last rewards interval as determined at block 403. Additionally the mailing functionality may be triggered by other customer behaviors that may signal value of providing additional financial education or services, e.g., the customer goes over-limit repeatedly. The communication/mailing vehicle may also be a proprietary online banking system with ability to provide confidential alerts or messages at a customer account level OR a customer service phone call OR a reminder from a customer service representative for inbound calls. Further, the communication may be bundled with access to tools such as balance reduction tools showing how customers can pay off balances faster.

With an aspect of the embodiments, quality controls may be incorporated to insure that a customer receives a fixed reward in accordance with the criteria of the rewards program. For example, quality measures may be performed to ascertain that all rewards are presented to the customer by looking back at customer-payment activity data a predetermined number of days with respect to the reward duration.

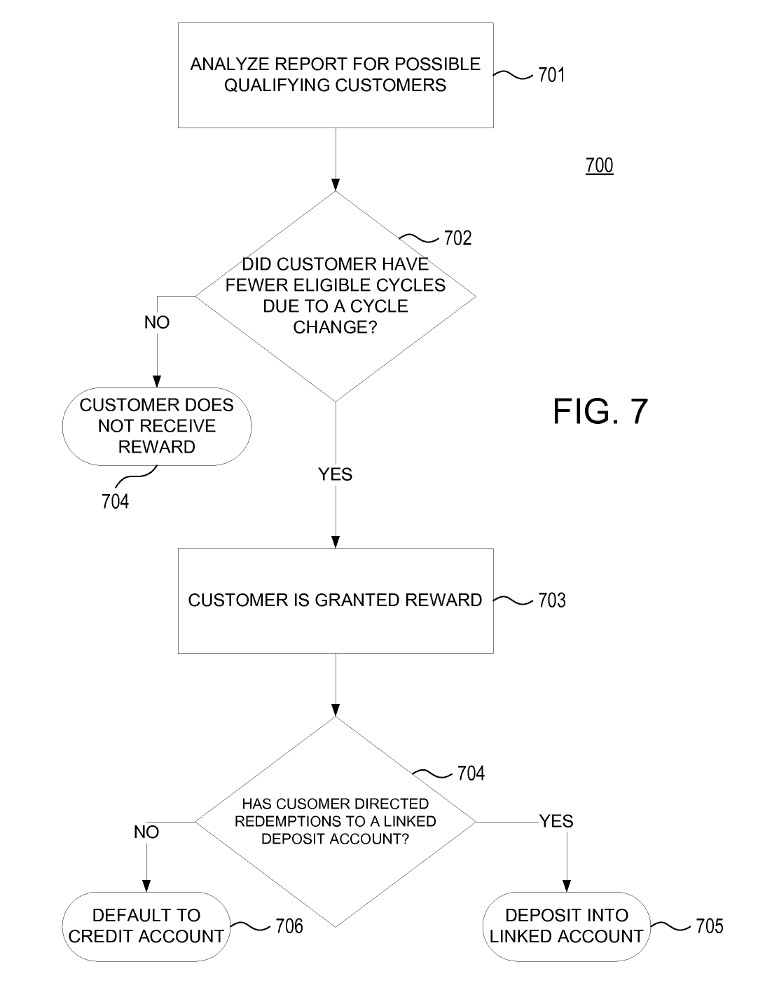

Also, quality controls may be performed to determine if the payment cycle has changed for the last payment. FIG. 7 shows flow diagram 700 for payment cycle change mitigation in accordance with an aspect of the invention. For example, a customer may specify a different payment date for the customer's credit card account to better match when the customer receives a pay check.

At block 701, process 700 analyzes a report for possible qualifying customers, where the report includes customers who did not earn a reward, had the last two qualifying payments in the quarter, and initiated a cycle change. For example, a customer may choose a better day to pay the customer's credit card bill each month. This capability may provide the customer to facilitate payment of credit card bills. As another example, the financial institution providing the credit card may change the payment due date or the duration of the billing cycle to align to the financial institution's processing system. Process 700 determines whether a customer had only two billing cycles that qualified at block 702. Since the customer incurs a billing cycle change, process 700 determines that the missing third cycle should qualify because of the change of the date that the payment is due, the customer is granted a reward for the quarter at block 703 (since the other two cycles' payments were qualifying). Otherwise, processing for the customer exits at block 704.

If the customer qualifies for the reward, a fixed amount is directed to the customer's linked account at block 705 or credited the customer's credit card account at block 706 as determined at block 704.

With some embodiments, additional quality controls (not explicitly shown in FIG. 7) may be incorporated. For example, a quality control can be incorporated for processing service exceptions. When correspondence (e.g., via e-mail or telephone or through the Internet) is received from a customer about not being award a reward, quality control can determine whether a reward should be granted. If so, the payment statement is adjusted with a determined fixed reward amount.

With some embodiments, a customer who is disputing merchant charges is not responsible for paying those charges until the dispute is resolved. In such a case, the disputed amount is not required to be paid in accordance with the minimum balance criteria to qualify for the fixed reward.

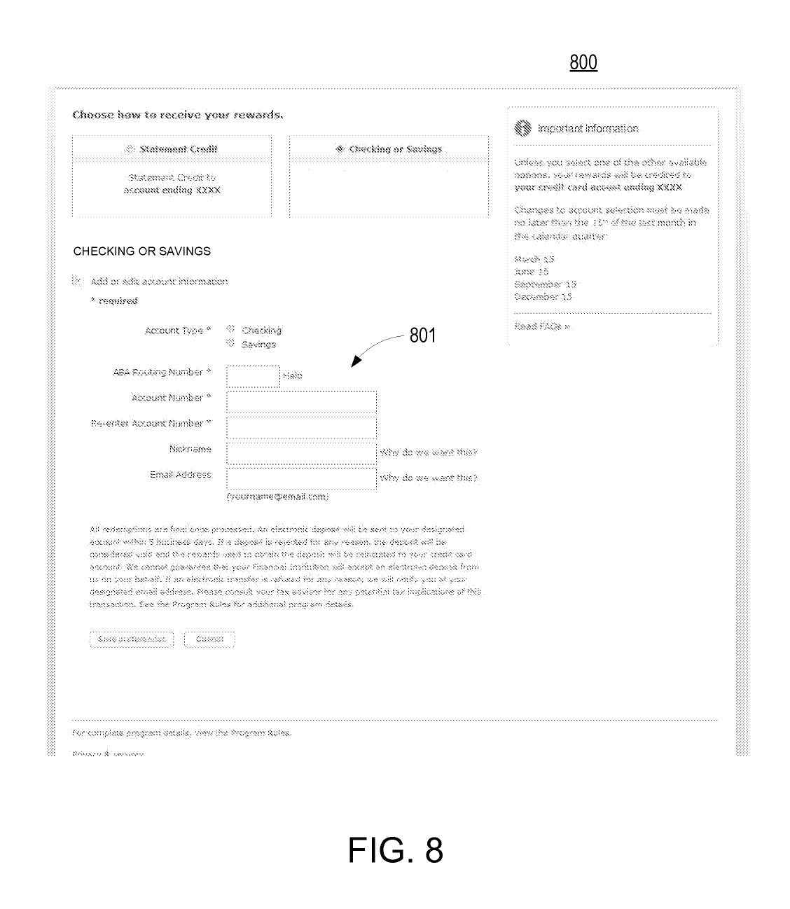

FIG. 8 shows exemplary screenshot 800 in which a customer designates an account for automatic rewards crediting in accordance with an aspect of the invention. For example, with some embodiments, screenshot 800 is accessed through the financial institution's website and the customer's computer device (e.g., personal computer device 141 or mobile device 161 as shown in FIG. 1), in which the customer is authenticated to access the customer's credit card account. Moreover, the customer may have other accounts (e.g., savings, checking, debit card, and loan-related) with the financial institution. In addition, the customer may change the designated account by subsequently accessing the webpage. With some embodiments, if the customer does not provide information for the designated account, the fixed rewards may be directed to the customer's credit card account by default.

With some embodiments, a customer can designate an account at the financial institution other than a credit card or deposit account, e.g. their mortgage account.

Screenshot 800 shows designated account information area 801 to enable the customer to specify the checking or saving account within the financial institution, to which the customer wants automatic rewards directed. The designated account may be with the financial institution providing the credit card. With some embodiments, the customer may designate an account at another financial institution for a reward deposit.

With some embodiments, a customer may be able to designate a reward to a charity or a dependent.

With an aspect of the embodiments, while not explicitly shown, screenshot 800 provides offers with partnering vendors. For example, a customer may designate that fixed rewards be accumulated and later redeemed for cash, travel, merchandise, and/or gift card.

Referring to FIGS. 1-7, processes 300, 400, 500, 651-654, and 700 may be performed by computing device 101 by executing computer-executable instructions that are stored in memory 115 (as shown in FIG. 1). For example, with some embodiments payment information payment criteria information may be contained in database 121 stored in memory device 115. Processor 103 may process the above data in accordance with processes 300-700 to determine whether the customer qualifies for a fixed reward. If so, processor 103 may communicate with other computer systems 151, 201, and/or 204 via communications module 109 to direct the reward to the customer's designated account.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments. They may determine that the requirements should be applied to third party service providers (e.g., those that maintain records on behalf of the company).

We claim:

1. A computer-assisted method comprising:
generating, by a processor, an account statement from a financial institution for a financial account for a customer by accessing at least one memory device storing account information;
determining, by the processor, whether the customer qualifies for a fixed reward during a calendar interval based on at least one account criterion spanning a predetermined number of consecutive account cycles by accessing the at least one memory device for customer; and
when the customer qualifies based on the determining, the processor directing a first fixed cash amount to a designated destination as indicated in account information stored in the at least one memory device.

2. The method of claim 1, wherein the financial account comprises a credit card account, the account statement comprises a billing statement, the at least one account criterion comprises at least one payment criterion, and the consecutive account cycles comprise consecutive billing cycles.

3. The method of claim 2, further comprising:
receiving an indication for the designated destination where to direct the first fixed cash amount.

4. The method of claim 3, wherein the designated destination comprises an account with the financial institution.

5. The method of claim 3, wherein the designated destination is for the benefit of a charity that is selected by the customer.

6. The method of claim 2, further comprising:
adjusting the first fixed amount to a different value based on a predetermined economic characteristic.

7. The method of claim 6, wherein the predetermined economic characteristic comprises an annual rate of inflation.

8. The method of claim 2, further comprising:
when the customer qualifies for the fixed reward, directing a second fixed cash amount when the customer has a specific relationship with the financial institution.

9. The method of claim 8, wherein the specific relationship occurs when the customer has another account with the financial institution.

10. The method of claim 8, further comprising:
when the customer performs a predetermined set of actions, directing a third fixed cash amount to the designated destination.

11. The method of claim 10, wherein the predetermined set of actions includes paying on-line.

12. The method of claim 2, wherein the at least one payment criterion comprises making a minimum payment by a predetermined date over the predetermined number of consecutive billing cycles.

13. The method of claim 12, wherein the at least one payment criterion comprises maintaining a minimum outstanding balance for each billing cycle.

14. The method of claim 2, wherein the at least one payment criterion comprises at least one of a minimum spending level for the credit card account, a minimum number of transactions for the credit card account, and a predetermined payment amount over a minimum amount.

15. The method of claim 2, wherein the determining comprises:
adjusting alignment of billing cycles during the calendar interval when a payment due date changes.

16. The method of claim 2, further comprising:
receiving a payment indication from the customer, wherein the payment indication is indicative of fixed payment incremental amount over a minimum payment; and
setting a payment amount due for a billing cycle to the minimum payment plus the fixed payment incremental amount.

17. The method of claim 1, further comprising:
converting the first fixed cash amount to a discount with a participating merchant.

18. The method of claim 1, further comprising:
converting the first fixed cash amount to a gift card with a participating merchant.

19. The method of claim 2, wherein the customer opens the financial account during the calendar interval, the method further comprising:
when the at least one payment criterion is satisfied for all remaining billing intervals of the calendar interval, directing the first fixed cash amount to the designated destination

20. An apparatus comprising:
at least one memory device; and
at least one processor coupled to the at least one memory and configured to perform, based on instructions stored in the at least one memory:
generating a billing statement from a financial institution for a credit card account of a customer by accessing at least one memory device for billing information;
determining whether the customer qualifies for a fixed reward during a calendar interval based on at least one payment criterion by accessing the at least one memory device for customer, wherein the fixed reward comprises a first fixed amount is adjustable based on a predetermined economic characteristic and wherein the determining is independent of a total purchase amount against the credit card account;
when the customer qualifies based on the determining, directing a first fixed cash amount to a designated destination as indicated in account information stored in the at least one memory device; and
subsequently adjusting the first fixed amount to a different amount based on a predetermined economic characteristic.

21. The apparatus of claim 20, wherein the at least one processor is further configured to perform:
receiving an indication for the designated destination where to direct the first fixed amount.

22. The apparatus of claim 20, wherein the at least one processor is further configured to perform:
when the customer qualifies for the fixed reward, directing a second fixed cash amount when the customer has a predefined relationship with the financial institution.

23. The apparatus of claim 20, wherein the at least one payment criterion comprises making a minimum payment by a predetermined date over a predetermined number of billing cycles over the calendar interval.

24. The apparatus of claim 20, wherein the at least one payment criterion comprises at least one of a minimum spending level for the credit card account, a minimum number of transactions for the credit card account, and a predetermined payment amount over a minimum amount.

25. The apparatus of claim 20, wherein the at least one processor is further configured to perform:
receiving an indication for the designated destination where to direct the first fixed cash amount.

26. A non-transitory computer-readable storage medium storing computer-executable instructions that, when executed, cause a processor to perform:
generating a billing statement from a financial institution for a credit card account for a customer by accessing at least one memory device for billing information;
determining whether the customer qualifies for a fixed reward during a calendar interval based on at least one payment criterion, wherein the at least one payment criterion comprises making a minimum payment by a predetermined date over a predetermined number of billing cycles over the calendar interval; and
when the customer qualifies based on the determining, directing a first fixed cash amount to a designated destination.

27. The computer-readable medium of claim 26, wherein the computer-executable instructions, when executed, cause the processor to perform:
receiving an indication for the designated destination where to direct the first fixed cash amount.

28. The computer-readable medium of claim 26, wherein the computer-executable instructions, when executed, cause the processor to perform:
adjusting the first fixed amount to a different value based on a predetermined economic characteristic.
